(19) United States
(12) Patent Application Publication
(10) Pub. No.: US 2008/0205814 A1
(43) Pub. Date: Aug. 28, 2008

(54) Method and Apparatus for Dynamic Polarization Mode Dispersion Compensation

(76) Inventors: Lijie Qiao, Ottawa (CA); Suet Fan Yuen, Kanata (CA); John Bradshaw Mills, Ottawa (CA)

Correspondence Address: Gowling Lafleur Henderson LLP, Suite 2600, 160 Elgin Street, Ottawa, ON, K1P 1C3, omitted

(21) Appl. No.: 11/677,627

(22) Filed: Feb. 22, 2007

(51) Int. Cl. G02B 6/00

(52) U.S. Cl. 385/11

(57) ABSTRACT

A method and a system for dynamic compensating polarization mode dispersion (PMD) in an optical communication system. An optical input signal passes through a compensating element first. A splitting device taps a fraction of the optical input signal and sends it to a monitoring element with birefringence properties. The monitoring element separates the fraction into two split signals with orthogonal principal states of polarization. The split signals are detected at photodetectors. An optimised coefficient is obtained from the detected split signals, and used to calculate an angle between a fast axis of the monitoring element and the fast axis of the optical fiber. The compensating element is set according to the determined angle to compensate the PMD. One or both of the monitoring element and the compensating element may be liquid crystal.

### FIELD OF INVENTION

The present invention relates generally to dispersion compensation in optical fiber transmission systems. In particular, this invention relates to polarization mode dispersion (PMD) compensation in optical fiber transmission systems.

### BACKGROUND

Modern wavelength division multiplexing (WDM) techniques permit the simultaneous transmission of multiple high bandwidth channels on respective wavelengths in an optical medium in communication networks. Polarization-mode dispersion (PMD) has become one of the limiting factors for such high bandwidth transmission systems.

A single-mode optical fiber carrying an optical signal of arbitrary polarization can be considered as a linear superposition of two orthogonally polarized HE₁₁ modes. Ideally, in a single mode fiber, the two optical modes are degenerate in terms of their propagation properties owing to the cylindrical symmetry of the fiber.

Real optical fibers, however, have some unintentional loss of circular symmetry. The randomly varying birefringence of a fiber may be a result of the fiber manufacturing process, stresses on the fiber from cabling or environment effects such as temperature and vibration. Whether this asymmetry occurs during manufacturing or is due to external forces, the loss of circular symmetry gives rise to two distinct polarization modes, with distinct phase and group velocities.

In the time domain, the differential group velocity is expressed as a propagation time difference known as the differential group delay (DGD), when an optical signal is propagated in the two orthogonally polarized HE₁₁ modes.

PMD can be represented, to the first order, by differential group delay between two orthogonal principal states of polarization (PSP) with a fast axis and a slow axis, respectively. Since the birefringence of a fiber varies randomly along a fiber link, differential group delay is a random variable that has a Maxwellian probability density function, i.e. the maximum instantaneous differential group delay can be several times above the average differential group delay. The mean differential group delay grows as the square root of the length of the system.

When an optical signal propagates down a fiber, the two component principal states of polarization of the light signal travel along the fast and slow axes of the fiber. Differential group delay may therefore result in bit-spreading of the optical signals. For signal propagating at 2.5 Gb/s or below, the impact of PMD for most fiber plant that has been deployed is minimal. As the data rate increases beyond 2.5 Gb/s towards 10 and 40 Gb/s, the signal pulse width narrows and the effect of PMD is the spreading of the original pulse in time, resulting in an overflow into a time slot of the transmitted signal which has been allotted to another bit, resulting in high BER and limiting total transmission distance.

All states of polarization (SOP) of an optical signal can be represented on a Poincaré sphere at the same time by assigning each state of polarization its own specific point on the Poincaré sphere. Points on the equator represent states of linear polarization, the poles represent right-hand and left-hand circular polarization, and other points on the sphere represent elliptical polarization.

One effective way of managing PMD is to reduce transmission distance by regeneration. However, this is a very costly option, in particular in WDM systems where channel capacity is high.

Another approach is to negate the effect of PMD before the optical signal is decoded by the optical receiver through the use of PMD compensators. The PMD compensators accomplish this task by delaying one state of polarization with respect to the other by the amount of differential group delay.

Various designs and configurations for PMD compensators have been proposed in the art.

U.S. Pat. No. 5,793,511 describes an optical receiver, which receives and evaluates an optical signal with PMD. The optical receiver has a splitting facility splitting the optical signal into two electrical signal components. The electrical signal components are processed in an equalizing circuit. A control facility controls the splitting facility with the aid of a quality signal produced by the equalizing circuit.

U.S. Pat. No. 6,674,936 teaches a system and a method using a wavelength-locked loop servo-control circuit and methodology that detects a PMD characteristic of the optical signal and enables real time adjustment of the center wavelength of the optical signal at the transmitter to minimize PMD in the optical fiber link.

The disadvantages of using electronic devices to apply PMD corrections are complex and potentially costly, and signal processing technologies are often required.

U.S. Pat. No. 6,661,937 describes an apparatus for changing the polarization state of an optical signal. The apparatus includes sequentially connected phase shifters, each of the phase shifters is adapted to exert a force on an optical fiber disposed in the respective shifter. Each of the phase shifters includes a registration key which selectively orients an axis of the optical fiber disposed in the registration key at a predetermined azimuth.

Applying mechanical stress may result in breakage and coating delamination of the fiber and cause long term reliability issues.

Therefore, all optical PMD compensation, in which the optical signal traffic remains in the optical domain, is the preferred choice for high bandwidth optical communications.

A typical PMD compensator (PMDC) employing adaptive optics in an optical fiber system is shown in FIG. 1. A fiber optic system 100 includes a transmitter 102, the optical transmission span 104, and a receiver 106. The PMD compensator includes the polarization controller 108 and PMD compensating element 110. To correct the polarization state of optical signals emerging from the optical transmission span 104, the polarization controller 108 typically transforms the state of polarization of the optical signals into prescribed or preferred polarization states of the PMD compensating element 110. The PMD compensating element 110 may comprise a single-mode fiber which have polarization mode attenuating or maintaining properties with intentionally asymmetric cores. In fiber with attenuating properties, a first polarization mode is transmitted normally, whereas the orthogonal polarization mode is subject to attenuation, effectively stripping that mode and leaving the first mode for signal transmission. In polarization-maintaining fiber, input signal is split into two orthogonal modes along a core with an asymmetry which defines and maintains different refractive indices for each polarization. The two polarization modes travel at different speeds due to the relative refractive indices.

The principal state of polarization of the incoming optical signals is rotated to align with the polarization controller 108. Adjustments are then applied in the PMD compensating element 110 to the optical signal to remove the differential group delay between the component polarizations of the signal. The degree of polarization is monitored 112 by a polarimeter 114. Control electronics 116 provides a feedback signal 118 to the polarization controller 108 to provide the optimized principal state of polarization.

Therefore, prior art PMD compensator as described in FIG. 1 generally rotates the incoming signal to align its principal state of polarization with the compensator element. This may require complex precision control algorithm and apparatus. In addition, the direction of the PMD in the incoming signal may not be easily determined. Furthermore, the monitored polarization compensation may be a result of both the alignment of the PMD axis of the incoming signal and the effect of the compensating element.

Therefore, there is a need for a simple technique for implementing PMD compensation.

### SUMMARY OF THE INVENTION

In accordance with one aspect of the present invention there is provided an apparatus for compensating polarization mode dispersion in an optical communication system comprising: an input for receiving an optical input signal having two orthogonal principal states of polarization, and a differential group delay between the two orthogonal principal states of polarization resulting in polarization mode dispersion; the input operable to connect to an optical fiber having a fast axis and a slow axis, the fast axis being orthogonal to the slow axis; a compensating element connected to the input for compensating the polarization mode dispersion; a splitting device connected to the compensating element for tapping a fraction of the optical input signal; a monitoring element having birefringence properties for receiving the fraction; the monitoring element separating the fraction into two split signals with orthogonal principal states of polarization according to the birefringence properties of the monitoring element; detecting devices for registering the split signals; and a processor connected to the detecting devices for determining an optimised coefficient, the optimised coefficient being indicative of an angle between a fast axis of the monitoring element and the fast axis of the optical fiber.

Preferably, the compensating element is adjusted according to the angle between a fast axis of the monitoring element and the fast axis of the optical fiber, for providing desired polarization mode dispersion.

Preferably, the compensating element is a liquid crystal.

Preferably, the monitoring element is a liquid crystal.

Preferably, the detecting devices are photodetectors, the photodetectors register voltages V_{PD1} and V_{PD2} based on:

V_{PD1}=[Sᵢₙ cos(α)cos(β)+Sᵢₙ cos(α)cos(β)]²

V_{PD2}=[−Sᵢₙ cos(α)sin(β)+Sᵢₙ sin(α)cos(β)]²
wherein Sᵢₙ is the fraction of the optical input signal; α is an angle between the principal state of polarization of the optical input signal and the fast axis of the optical fiber; and β is an angle between the fast axis of the monitoring element and the fast axis of the optical fiber.

Preferably, the coefficient is:

Coeff(α,β,PMD)=∫V_{PD1}V_{PD2}dt

Preferably, the processor is a digital signal processor.

In accordance with another aspect of the present invention there is provided a method for compensating polarization mode dispersion in an optical communication system comprising the steps of: receiving an optical input signal having polarization mode dispersion (PMD); passing the optical signal through a compensating element; tapping a fraction of the optical input signal at a splitting element; separating the tapped fraction into two split signals having orthogonal principal states of polarizations (PSP) using a monitoring element having a fast axis; determining the split signals; adjusting the fast axis of the monitoring element for determining an optimized coefficient for the split signals; and setting the compensating element based on the optimized coefficient, to compensate PMD in the optical input signal.

Preferably, the step of adjusting the fast axis of the monitoring element further comprises the steps of determining an angle between the fast axis of the monitoring element and a fast axis of an optical fiber carrying the optical input signal.

Preferably, the compensating element is a liquid crystal.

Preferably, the monitoring element is a liquid crystal.

Preferably, the split signals are determined by:

V_{PD1}=[Sᵢₙ cos(α)cos(β)+Sᵢₙ cos(α)cos(β)]²

V_{PD2}=[−Sᵢₙ cos(α)sin(β)+Sᵢₙ sin(α)cos(β)]²
wherein V_{PD1} and V_{PD2} are voltages registered at photodetectors; Sᵢₙ is the fraction of the optical input signal; α is an angle between the PSP of the optical input signal and a fast axis of an optical fiber; and β is an angle between the fast axis of the monitoring element and the fast axis of the optical fiber.

Preferably, the coefficient is:

Coeff(α,β,PMD)=∫V_{PD1}V_{PD2}dt

Unless otherwise defined, all technical and scientific terms used herein have the same meaning as commonly understood by one of ordinary skill in the art. All publications, patent applications, patents, and other references mentioned herein are incorporated by reference in their entirety. In case of conflict, the present specification, including definitions, will control. In addition, the apparatus, methods, and examples are illustrative only and not intended to be limiting.

### BRIEF DESCRIPTION OF THE FIGURES

The invention and the illustrated embodiments may be better understood, and the numerous objects, advantages, and features of the present invention and illustrated embodiments will become apparent to those skilled in the art by reference to the accompanying drawings. In the drawings, like reference numerals refer to like parts throughout the various views of the non-limiting and non-exhaustive embodiments of the present invention, and wherein:

FIG. 1 is a block diagram of a prior art polarization mode dispersion compensator;

FIG. 2 is a block diagram of an exemplary embodiment of an apparatus operable to provide dynamic polarization mode dispersion according to the teaching of the present invention;

FIG. 3 shows a projection of a Poincaré sphere for describing the determination of the fast axis of the input optical fiber;

FIGS. 4 (A) and (B) are graphs showing the relationship between power and the angle between the fast axis of the incoming fiber and the fast axis of the monitoring element;

FIG. 5 (A) depicts the coefficient in relation to the adjustment of the angle between the fast axis of the incoming fiber and the fast axis of the monitoring element;

FIG. 5 (B) depicts the coefficient as a function of differential group delay; and

FIG. 6 is a flowchart showing one example of a method for dynamic polarization mode dispersion compensation.

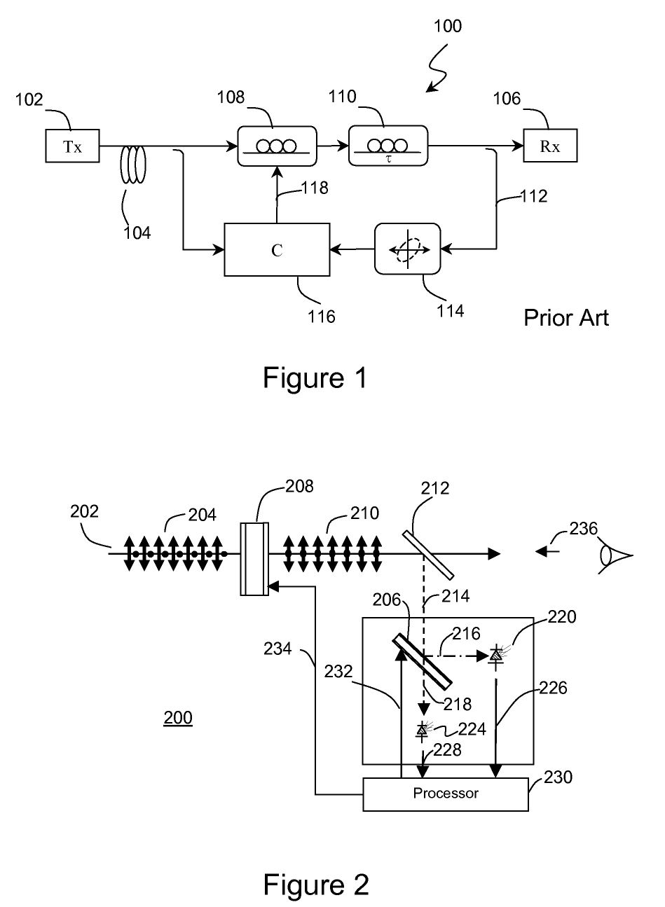

### DETAILED DESCRIPTION

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In accordance with one aspect of the present invention, the monitoring and/or compensating elements of the PMD compensator are rotated to align with the state of polarization of the incoming signal. The monitoring components tracks the fast and slow axes of the fiber based on the polarization of the incoming signal. In a preferred embodiment, the inherent birefringence properties of liquid crystal are used for monitoring and/or compensating PMD. In another preferred embodiment, optical power is correlated to align the fast and slow axes of the compensating element and the state of polarization of the optical signal.

Liquid crystal may be used as a polarization controller. Liquid crystals exhibit birefringence, which is a function of the orientation of the liquid crystal molecules that derive their anisotropic physical properties from the orientation of their constituent molecules. The orientation can be controlled by the intensity of an applied electric field.

Reorientation of the liquid crystal molecules under the influence of the applied electric field introduces elastic strains in the material. These strains stem from constraints imposed on the molecular orientation at the boundaries confining the liquid crystal. These surface constraints, or surface anchoring, are such that molecules close to the surface are not free to reorient, and remain substantially along some preferred direction.

When an electric field is applied to a liquid crystal element, the directors of the liquid crystal molecules are reoriented in response to the applied field.

FIG. 2 provides an exemplary embodiment of the PMD compensator 200 in accordance with the present invention. The PMD compensator 200 receives an optical signal 202 with differential group delay 204. The PMD compensator 200 includes a monitoring element 206, which is used to locate the principal state of polarization of the optical signal. The monitoring element 204 may be a liquid crystal. The PMD compensator 200 further comprises a compensating element 208, which is capable to align its fast axis with the fast axis of the fiber and applies the necessary delay to compensate the DGD from the fiber, resulting in an optical signal with reduced PMD 210. The compensating element 208 may also be a liquid crystal.

In operation, the compensating element 208 receives an incoming optical signal 202. A small percentage, for example, 5% of the signal is tapped off to the monitoring element 206 at a splitting element 212. The tapped signal 214, S_{IN}, is then separated into two split signals with orthogonal principal states of polarization, S_{F} 216 and S_{S} 218, according to the birefringence properties of the monitoring element 206, for example, the birefringence properties of a liquid crystal.

Detecting devices, such as photodetectors PD₁ 220 and PD₂ 224 register voltages, V_{PD1} 226 and V_{PD2} 228, corresponding to the amount of light detected. The registered voltages are sent to a processor 230, for example, a digital signal processor (DSP).

The processor 230 then applies a control signal 232 to the monitoring element 206, in an exemplary embodiment a voltage to align a monitoring liquid crystal, such that a correlation coefficient is optimized. A corresponding control signal 234 can then be applied to the compensating element 208 such that the appropriate delay is applied to the optical signals 202 to compensate for the PMD. An example of the control signal 234 is a voltage applied to a compensating liquid crystal to provide an appropriate birefringence for compensating the PMD in the received optical signal.

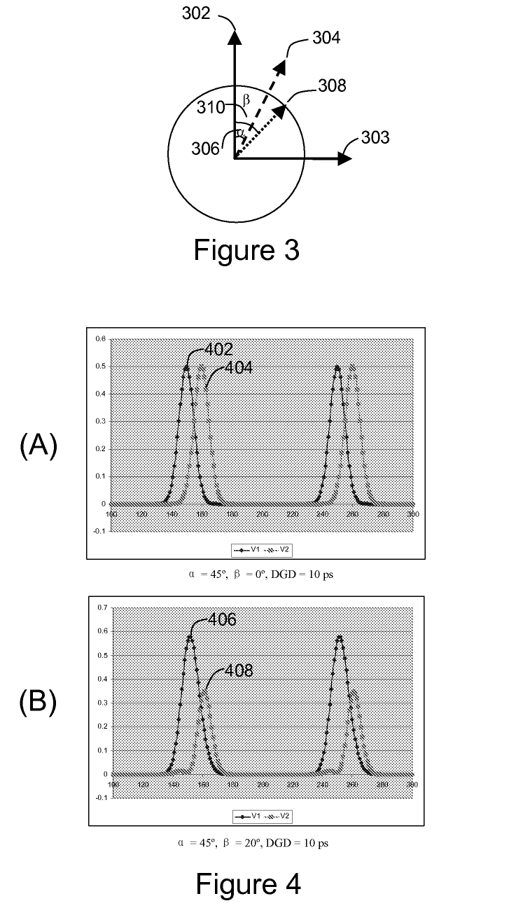

FIG. 3 shows a presentation of PMD as viewed from the direction 236 illustrated in FIG. 2. In this view, vector 302 represents the fast axis of the input fiber, vector 303 represents the slow axis of the input fiber, vector 304 represents the principal state of polarization of the incoming optical signal 202. The vectors 302 and 304 form an angle α 306, i.e. an angle between the principal state of polarization of the incoming optical signal and the fast axis of the input fiber. The vector 308 represents the fast axis of the monitoring element 206. The vectors 302 and 308 form an angle β 310, i.e., an angle between the fast axis of the monitoring element 206 and the fast axis of the input fiber.

The fast axis of the input fiber, represented by the vector 302, is actually unknown at the beginning of the process. By manipulating the monitoring element 206 and observing the changes of the voltages V_{PD1} 226 and V_{PD2} 228 on photodetectors PD₁ 220 and PD₂ 224, the angles α 306 and β 310 can be calculated based on the voltages V_{PD1} 226 and V_{PD2} 228:

V_{PD1}=[Sᵢₙ cos(α)cos(β)+Sᵢₙ cos(α)cos(β)]²

V_{PD2}=[−Sᵢₙ cos(α)sin(β)+Sᵢₙ sin(α)cos(β)]²

Referring to FIG. 4, the x-axis represents time and the y-axis is the voltage registered at the photodetectors 220, 224 illustrated in FIG. 2. The curves 402, 406 are the voltages registered at the photodetector 220 and the curves 404, 408 are the voltages registered at the photodetector 224. FIG. 4 (A) illustrates detected voltages of an optical signal with a differential group delay of 10 ps. The fast axis of the input fiber aligns with the fast axis of the monitoring element (β=0°) and forms a 45° angle with the principal state of polarization of the optical signal (α=45°). This alignment results in comparable voltages being detected at photodetectors 220 and 224.

FIG. 4 (B) illustrates detected voltages of an optical signal with a differential group delay of 10 ps. The fast axis of the input fiber forms an angle of 20° with the fast axis of the monitoring element (β=20°) and forms a 45° angle with the principal state of polarization of the optical signal (α=45°). This alignment results in a higher voltage being detected at photodetector PD₂ 224.

Accordingly, a coefficient can be calculated as:

Coeff(α,β,PMD)=∫V_{PD1}V_{PD2}dt

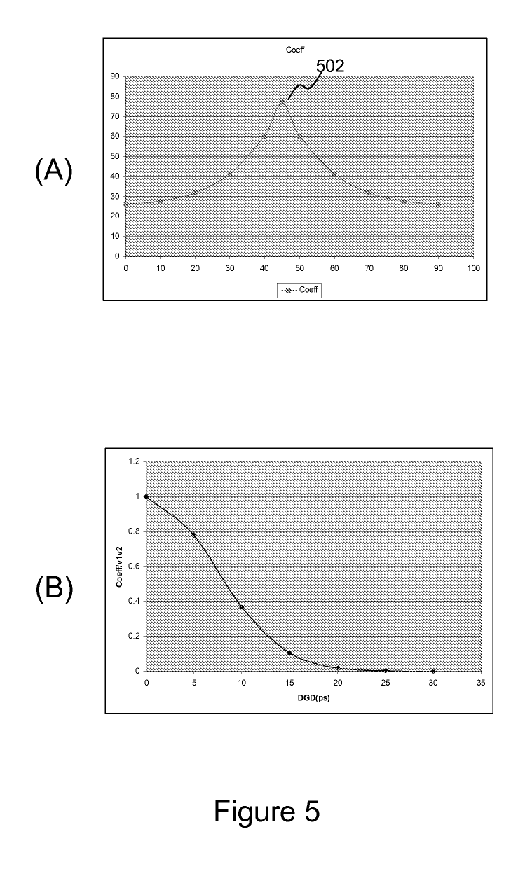

Referring to FIG. 5 (A), where the x-axis is the angle (β) between the fast axis of the input fiber and the fast axis of the monitoring element 206, the fast axis of the monitoring element 206 is best aligned with the fast axis of the input fiber when the coefficient reaches a peak 502. Therefore, the position of the fast axis in the input fiber is determined based on the values of the coefficient.

FIG. 5 (B) shows the coefficient as a function of the differential group delay of the compensating element. As the ratio of coefficient to V_{PD1} 226 and V_{PD2} 228 is varied, so is the differential group delay.

In a preferred embodiment, the fast axis of the compensating element 208 is controlled based on the determined position of the fast axis of the input fiber. Therefore, instead of using a polarization controller to adjust the state of polarization of the incoming optical signal as in the prior art PMD compensators, the present invention adjusts the fast axis of the compensating element, for example, the fast axis of a birefringent liquid crystal, based on the fast axis of a monitoring element, for example, the fast axis of a second birefringent liquid crystal.

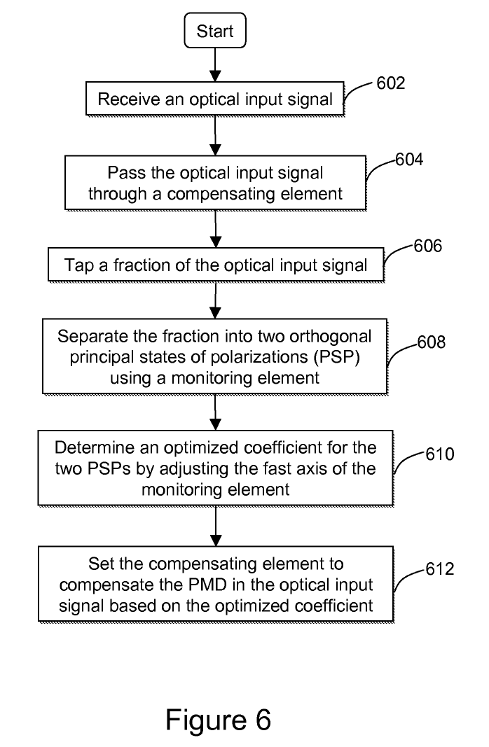

FIG. 6 illustrates a flowchart showing one example of a method in accordance with one embodiment of the present invention. Also referring to FIG. 2, an optical input signal 202 is received at the PMD compensator 200 at step 602. The optical signal passes through a compensating element 208 at step 604. A fraction 214 of the optical input signal is tapped at a splitting element at step 606. The tapped fraction is separated into two split signals with orthogonal principal states of polarization (PSP) 216, 218 using a monitoring element 206. The fast axis of the monitoring element 216 is adjusted to determine an optimized coefficient for the two PSPs at step 610. The compensating element 208 is then set to compensate the PMD in the optical input signal based on the optimized coefficient at step 612.

Although various aspects of the present invention have been described in several embodiments, a myriad of changes, variations, alterations, transformations, and modifications may be suggested to one skilled in the art, and it is intended that the present invention encompass such changes, variations, alterations, transformations, and modifications as fall within the spirit and scope of the appended claims.

1. An apparatus for compensating polarization mode dispersion in an optical communication system comprising:
an input for receiving an optical input signal having two orthogonal principal states of polarization, and a differential group delay between the two orthogonal principal states of polarization resulting in polarization mode dispersion; the input operable to connect to an optical fiber having a fast axis and a slow axis, the fast axis being orthogonal to the slow axis;
a compensating element connected to the input for compensating the polarization mode dispersion;
a splitting device connected to the compensating element for tapping a fraction of the optical input signal;
a monitoring element having birefringence properties for receiving the fraction;
the monitoring element separating the fraction into two split signals with orthogonal principal states of polarization according to the birefringence properties of the monitoring element;
detecting devices for registering the split signals; and
a processor connected to the detecting devices for determining an optimised coefficient, the optimised coefficient being indicative of an angle between a fast axis of the monitoring element and the fast axis of the optical fiber.

2. The apparatus as claimed in claim 1, wherein the compensating element is adjusted according to the angle between a fast axis of the monitoring element and the fast axis of the optical fiber, for providing desired polarization mode dispersion.

3. The apparatus as claimed in claim 1, wherein the compensating element is a liquid crystal.

4. The apparatus as claimed in claim 1, wherein the monitoring element is a liquid crystal.

5. The apparatus as claimed in claim 1, wherein the detecting devices are photodetectors, the photodetectors register voltages V_{PD1} and V_{PD2} based on:
V_{PD1}=[Sᵢₙ cos(α)cos(β)+Sᵢₙ cos(α)cos(β)]²
V_{PD2}=[−Sᵢₙ cos(α)sin(β)+Sᵢₙ sin(α)cos(β)]²
and wherein Sᵢₙ is the fraction of the optical input signal; α is an angle between the principal state of polarization of the optical input signal and the fast axis of the optical fiber; and β is an angle between the fast axis of the monitoring element and the fast axis of the optical fiber.

6. The apparatus as claimed in claim 5, wherein the coefficient is:
Coeff(α,β,PMD)=∫V_{PD1}V_{PD2}dt

7. The apparatus as claimed in claim 1, wherein the processor is a digital signal processor.

8. A method for compensating polarization mode dispersion in an optical communication system comprising the steps of:
a) receiving an optical input signal having polarization mode dispersion (PMD);
b) passing the optical signal through a compensating element;
c) tapping a fraction of the optical input signal at a splitting element;
d) separating the tapped fraction into two split signals having orthogonal principal states of polarizations (PSP) using a monitoring element having a fast axis;
e) determining the split signals;
f) adjusting the fast axis of the monitoring element for determining an optimized coefficient for the split signals; and
g) setting the compensating element based on the optimized coefficient, to compensate PMD in the optical input signal.

9. The method as claimed in claim 8, wherein the step of adjusting the fast axis of the monitoring element further comprises the steps of determining an angle between the fast axis of the monitoring element and a fast axis of an optical fiber carrying the optical input signal.

10. The method as claimed in claim 8, wherein the compensating element is a liquid crystal.

11. The method as claimed in claim 8, wherein the monitoring element is a liquid crystal.

12. The method as claimed in claim 8, wherein the split signals are determined by:
V_{PD1}=[Sᵢₙ cos(α)cos(β)+Sᵢₙ cos(α)cos(β)]²
V_{PD2}=[−Sᵢₙ cos(α)sin(β)+Sᵢₙ sin(α)cos(β)]²
wherein V_{PD1} and V_{PD2} are voltages registered at photodetectors; Sᵢₙ is the fraction of the optical input signal; α is an angle between the PSP of the optical input signal and a fast axis of an optical fiber; and β is an angle between the fast axis of the monitoring element and the fast axis of the optical fiber.

13. The method as claimed in claim 12, wherein the coefficient is:
Coeff(α,β,PMD)=∫V_{PD1}V_{PD2}dt
